(19) United States
(12) Patent Application Publication
(10) Pub. No.: US 2025/0360966 A1
(43) Pub. Date: Nov. 27, 2025

(54) LOWER STRUCTURE OF VEHICLE

(71) Applicant: MAZDA MOTOR CORPORATION, Hiroshima (JP)

(72) Inventors: Eiji KAMEMOTO, Hiroshima (JP); Hirotaka NATSUME, Hiroshima (JP); Hideyuki TSUKAMOTO, Hiroshima (JP)

(73) Assignee: MAZDA MOTOR CORPORATION, Hiroshima (JP)

(21) Appl. No.: 19/084,199

(22) Filed: Mar. 19, 2025

(30) Foreign Application Priority Data
May 22, 2024 (JP) 2024-083020

(51) Int. Cl. B62D 21/15; B60R 16/04; B62D 25/02; H01M 50/242; H01M 50/249; H01M 50/262

(52) U.S. Cl. CPC B62D 21/157; B60R 16/04; B62D 25/025; H01M 50/242; H01M 50/249; H01M 50/262; H01M 2220/20

(57) ABSTRACT

A vehicle comprises a pair of side sills, a cross member, a battery, and a reinforcing member. The battery is arranged below the cross member and has a battery frame. The reinforcing member is stored in a hollow portion of the side sill and has a body portion having a closed-cross section. The body portion is arranged in an area which overlaps the cross member in a side view of the vehicle, when viewed from one side of a vehicle width direction. The side sill, the battery frame, and the reinforcing member are fixed by a bolt and a nut. The bolt penetrates a backet and its tip portion penetrates toward the body portion of the reinforcing member.

### BACKGROUND OF THE INVENTION

The present invention relates to a lower structure of a vehicle in which a battery is arranged below a floor.

In these days, a battery-type eclectic vehicle (BEV), a hybrid-type electric vehicle, or the like have prevailed considerably. A large-sized battery with a large capacity is installed under a floor in these kinds of vehicles. A battery-installment manner of a vehicle which is disclosed in Japanese Patent Laid-Open Publication No. 2018-131133 will be described referring to FIG. 8.

As shown in FIG. 8, in the vehicle of the patent document, a battery frame 920 of a battery 92 is fixed to a lower portion of a side sill 90. Specifically, the side sill 90 is combined by a side sill outer 900 positioned on an outward side, in a vehicle with direction, of a vehicle body and a side sill inner 901 positioned on an inward side, in the vehicle with direction, of the vehicle body, and the battery frame 920 is fixed to a lower wall portion 901c of the side sill inner 901 by a bolt BLT9 and a nut NT.

A cross member 91 is fixed to the side sill inner 901 of the side sill 90 such that it connects the side sill inner 901 to its opposite-side side sill 90. The cross member 91 is arranged above the battery 92.

Further, a stiffener (reinforcing member) 93 is stored in a hollow portion 90a inside the side sill 90 in the above-described vehicle. The stiffener 93 comprises a flat-plate shaped middle wall member 930 and a hat-section shaped outside member 931 and a hat-section shaped inside member 932. The stiffener 93 is configured such that its upper edge portion of the middle wall member 930 is interposed between an upper flange portion 900a of the side sill outer 900 and an upper flange portion 901a of the side sill inner 901, and its lower edge portion is interposed between a lower flange portion 900b of the side sill outer 900 and a lower flange portion 901b of the side sill inner 901, and the stiffener 93 is fixed to the side sill 90.

In the above-described vehicle of the patent document, an inside member 932 of the stiffener 93 is configured such that its inner side is positioned upward.

In the structure of the above-described patent document, there is a concern that in a case where a collision load is applied to the side sill 90 which is positioned on one side, in the vehicle width direction, of the vehicle body, fixation of the side sill 90 positioned on the other side and the battery 92 may be released (detached). This will be described referring to FIG. 9. FIG. 9 shows respective moves of the side sill 90L, 90R, the cross member 91, and the battery 92 when a side-collision load F is applied to the right-side side sill 90R from a vehicle right side.

As shown in FIG. 9, when the side-collision load F is applied to the right-side side sill 90R from the vehicle right side, the cross member 91 is pressed leftward by the right-side sill 90R as shown by an arrow B1. The pressed cross member 91 moves leftward in accordance with a deformation amount of the right-side side sill 90R (arrow B2). Thereby, the side-collision load F is transmitted to the left-side side sill 90L via the cross member 91.

Herein, since the battery 92 installed under the floor is large and heavy, it tends to stay there due to its inertia. Thereby, an inverse move (rightward move) of the battery 92 relative to the cross member 91 and the left-side side sill 90L occurs. Accordingly, as shown by an arrow B3, there is a concern that at an opposite side to the side where the side-collision load is applied (i.e., left side), the fixation of the left-side side sill 90L and the battery 92 may be released because of breakage or the like.

While the case where the side-collision load F is applied from the vehicle right side was described above, there is a concern that fixation of the right-side side sill 90R and the battery 92 may be released when the side-collision load is applied from the vehicle left side.

### SUMMARY OF THE INVENTION

The present invention has been devised in view of the above-described problem, and an object of the present invention is to provide a lower structure of a vehicle which can properly suppress releasing of the fixation of the side sill and the battery even in a case where the side-collision load is applied to the side sill from the outward side, in the vehicle width direction, of the vehicle body.

The lower structure of the vehicle of the present invention comprises a pair of side sills arranged at both outward sides, in a vehicle width direction, of a floor of the vehicle, extending in a longitudinal direction of the vehicle, and having a closed-cross section with a hollow portion inside, respectively, a cross member extending in the vehicle width direction and fixed to the pair of side sills at both ends thereof, a battery arranged below the cross member under the floor of the vehicle and having a battery frame extending in the longitudinal direction of the vehicle on an inward side, in the vehicle width direction, of each of the pair of side sills, a reinforcing member stored in the hollow portion of each of the pair of side sills, the reinforcing member being configured such that at least part thereof has a closed-cross section and the part thereof having the closed-cross section is arranged in an area which overlaps the cross member in a side view of the vehicle, when viewed from one side of the vehicle width direction, and a fixing member to fix the battery frame of the battery to each of the pair of side sills, wherein the fixing member is configured such that part thereof penetrates the reinforcing member and the fixing member fixes the battery frame to the side sill together with the reinforcing member.

In the vehicle provided with the lower structure according to the present invention, since the part of the reinforcing member having the closed-cross section is arranged in the area which overlaps the cross member in the side view, the side-collision load applied to the side sill from the outward side, in the vehicle width direction, of the vehicle body is efficiently transmitted to the cross member. Further, even at the opposite side to the side where the load is applied, since the reinforcing member is the area which overlaps the cross member in the side view, the load transmitted via the cross member is efficiently transmitted to the side sill via the reinforcing member.

Further, in the vehicle provided with the lower structure according to the present invention, the reinforcing member and the battery frame are fixed to the side sill by the fixing member. Thereby, even in a case where the side-collision load is applied to the side sill from the vehicle outward side, the battery frame moves toward the opposite side to the application side of the load together with the cross member. Accordingly, even in a case where the side-collision load is applied to the one of the side sills, it can be suppressed that the fixation of the other-side side sill which is opposite to the load-application side and the battery is released.

Herein, since the battery installed under the vehicle floor in the electric vehicle or the like has the large capacity and the large size and is heavy, the battery frame is configured to have the high rigidity. Accordingly, it is unlikely that the battery frame where the load is transmitted via the fixing member is greatly deformed and broken compared to the cross member, so that relative move-difference between the cross member and the battery frame may not occur when the side-collision load is applied.

In the vehicle provided with the lower structure according to the present invention, the reinforcing member may comprise a body portion including the part of the reinforcing member having the closed-cross section and a bracket arranged below the body portion, and the fixing member may be configured such that part thereof penetrates the bracket and the fixing member fixes the bracket to the battery frame.

According to this structure, since the body portion of the reinforcing member includes the part of the reinforcing member having the closed-cross section and the bracket of the reinforcing member is fixed by the fixing member, when the side-collision load is applied, the high rigidity of the reinforcing member can be secured and also the firm fixation of the battery frame and the reinforcing member can be attained.

In the vehicle provided with the lower structure according to the present invention, the fixing member may be configured such that part thereof penetrates the body portion.

According to this structure, when the side-collision load is applied to the side sill, the battery frame can be made to move properly toward the opposite side to the load-application side together with cross member.

In the vehicle provided with the lower structure according to the present invention, a portion of the fixing member which penetrates the body portion may have a bar shape, and a portion of the body portion of the reinforcing member where the part of the fixing member penetrates may have an opening with a size which is larger than a sectional size of the bar-shaped portion of the fixing member.

According to this structure, the opening with the above-described size is formed at the body portion of the reinforcing member, and the bar-shaped portion of the fixing member penetrates through the above-described opening. That is, when the side-collision load is not applied to the side sill, the fixing member and the opening of the body portion do not contact each other, so that any contact noises can be suppressed from being generated between the fixing member and an inner peripheral face of the opening in the vehicle traveling. Meanwhile, in a case where the side-collision load is applied to the side sill and thereby the reinforcing member moves according to the deformation or move of the side sill, an outer face of the bar-shaped portion of the fixing member and the inner peripheral face contact each other. Thereby, part of the side-collision load applied to the side sill is transmitted to the battery frame via the fixing member as well, so that the battery frame can be made to move together with the cross member in the vehicle side collision.

In the vehicle provided with the lower structure according to the present invention, the side sill may be fixed to the battery frame in a state where part of an outer wall of the side sill is interposed between the bracket and the battery frame.

According to this structure, the part of the outer wall of the side sill is interposed between the bracket of the reinforcing member and the battery frame, and in this state, the side sill, the reinforcing member, and the battery frame are fixed together by the fixing member. Accordingly, the battery frame can be firmly fixed to the side sill and the reinforcing member. That is, compared to a case where the outer wall of the side sill is fixed in a state where a gap is generated between the bracket of the reinforcing member and the battery frame, when the side-collision load is applied from the vehicle outward side, the cross member and the battery frame do not have the move difference easily due to resistance caused by a face contact of the both. Accordingly, even when the side-collision load is applied to the one of the side sills, it can be further suppressed that the fixation of the other side sill opposite to the load-application side and the battery is released.

In the vehicle provided with the lower structure according to the present invention, the body portion of the reinforcing member may be fixed to the side sill at least one of an inward side and an outward side, in the vehicle width direction, thereof.

According to this structure, since the body portion including the part of the reinforcing member having the closed-cross section is fixed to the side sill, the body portion of the reinforcing member moves toward the vehicle inward side together with the side sill when the side-collision load is applied to the side sill. Thereby, the load transmission is conducted by the body portion of the reinforcing member moving together with the side sill, and the load is properly transmitted to the battery frame via the fixing member.

In the vehicle provided with the lower structure according to the present invention, the bracket may be fixed to the body portion of the reinforcing member.

According to this structure, when the side-collision load is applied to the side sill, the relative move-difference, in the vehicle width direction, between the body portion and the bracket does not occur easily. Thereby, even when the side-collision load is applied to the one of the side sills, it can be further effectively suppressed that the fixation of the other side sill opposite to the load-application side and the battery is released.

In the vehicle provided with the lower structure according to the present invention, at least part of the battery frame may have a closed-cross section, and the fixing member may fix the part of the battery frame having the closed-cross section to the side sill and the reinforcing member.

According to this structure, since the side sill and the reinforcing member are fixed by the part of the battery frame having the closed-cross section, it is suppressed that the battery frame is greatly deformed when the side-collision load is applied to the side sill. Thereby, even when the side-collision load is applied to the one of the side sills, it can be further effectively suppressed that the fixation of the other side sill opposite to the load-application side and the battery is released.

In the vehicle provided with the lower structure according to the present invention, the fixing member may be provided to extend upward, in a vertical direction, of the vehicle toward the reinforcing member from the part of the battery frame having the closed-cross section.

According to this structure, since the fixing member is provided to extend in the vertical direction, the battery is raised upward from a lower position and then the battery frame can be fixed to the side sill and the reinforcing member. That is, any troublesome operations (works) for installing the battery are unnecessary.

Further, when the side-collision load is applied to the side sill, the load can be transmitted to the battery frame via the fixing member extending in the vertical direction.

In the vehicle provided with the lower structure according to the present invention, each of the pair of side sills may comprise a side sill outer provided on the outward side, in the vehicle width direction, thereof and a side sill inner provided on the inward side, in the vehicle width direction, thereof and fixed to the side sill outer, and the battery frame and the reinforcing member may be fixed to the side sill inner by the fixing member.

According to this structure, since the battery frame and the reinforcing member are fixed to the side sill inner, even when the side-collision load is applied to part of the side sill, it can be suppressed that a joint point (by welding or the like) of the side sill inner and the vehicle body, such as a floor panel, is released (detached). That is, the side sill tends to be deformed in a bent shape in the plan view when the side-collision load is applied to the side sill. However, since the side sill and the reinforcing member are fixed to the battery frame having the high rigidity, it can be suppressed that the side sill is deformed in the bent shape by a reaction force from the battery frame. Accordingly, releasing of the joint point of the side sill and the vehicle body due to the application of the side-collision load to the part of the side sill can be suppressed properly.

Thus, the lower structure of the vehicle according to the present invention can properly suppress releasing of the fixation of the side sill and the battery even in a case where the side-collision load is applied to the side sill from the outward side, in the vehicle width direction, of the vehicle body.

The present invention will become apparent from the following description which refers to the accompanying drawings.

### BRIEF DESCRIPTION OF THE DRAWINGS

FIG. 1 is a plan view showing part of a vehicle provided with a lower structure according to an embodiment of the present invention.

FIG. 2 is a sectional view taken along line II-II of FIG. 1.

FIG. 3 is a perspective view showing part of a reinforcing member.

FIG. 4 is a perspective view of a bracket.

FIG. 5 is a schematic diagram to explain respective moves of a cross member and a battery in a case where a side-collision load is applied to one of side sills.

FIG. 6 is a sectional view of a lower structure according to a first modification.

FIG. 7 is a sectional view of a lower structure according to a second modification.

FIG. 8 is a sectional view of a lower structure according to the prior art.

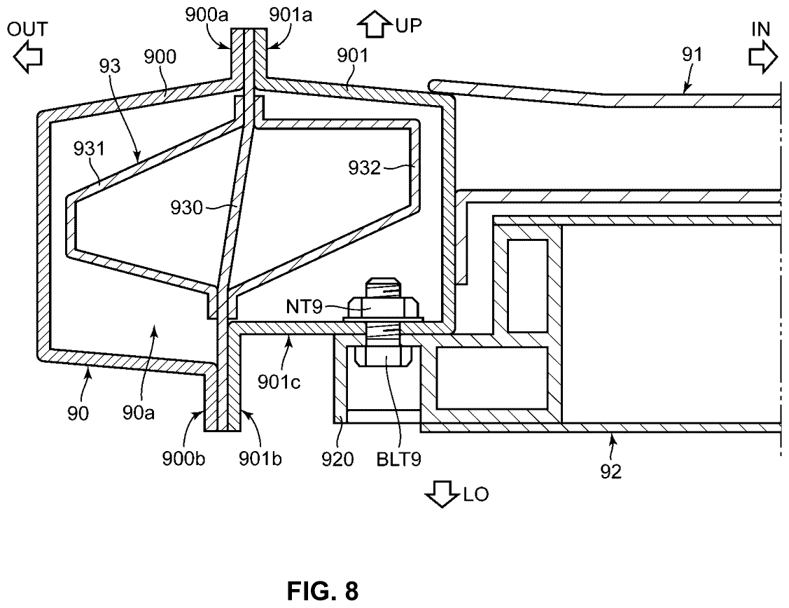

FIG. 9 is a schematic diagram to explain respective moves of a cross member and a battery in a case where a side-collision load is applied to a side sill in the lower structure according to the prior art.

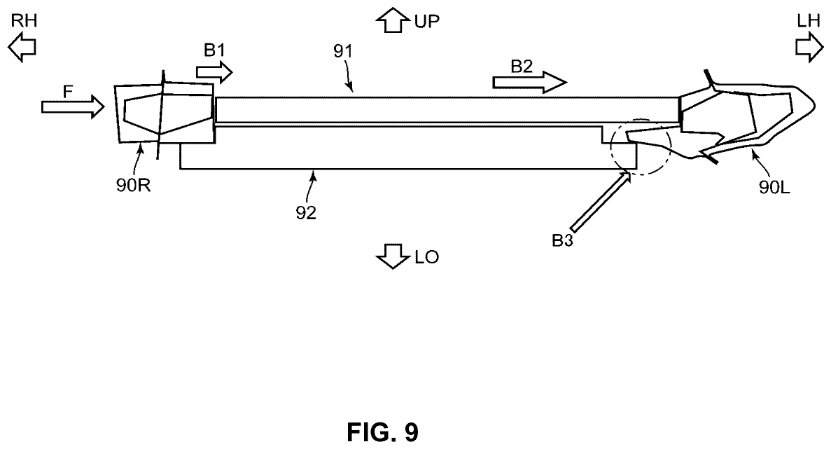

### DETAILED DESCRIPTION OF THE INVENTION

Hereafter, an embodiment of the present invention will be described referring to the drawings. The following description merely exemplifies the present invention, and the present invention is not limited to the following description except its substantial structure.

In figures referred to in the following description, “FR” shows a vehicle front (forward) side, “RR” shows a vehicle rear (rearward) side, “LH” shows a vehicle left (leftward) side, “RH” shows a vehicle right (rightward) side, “UP” shows a vehicle upper (upward) side, and “LO” shows a vehicle lower (downward) side.

### Embodiment

### 1. Structure of Vehicle 1

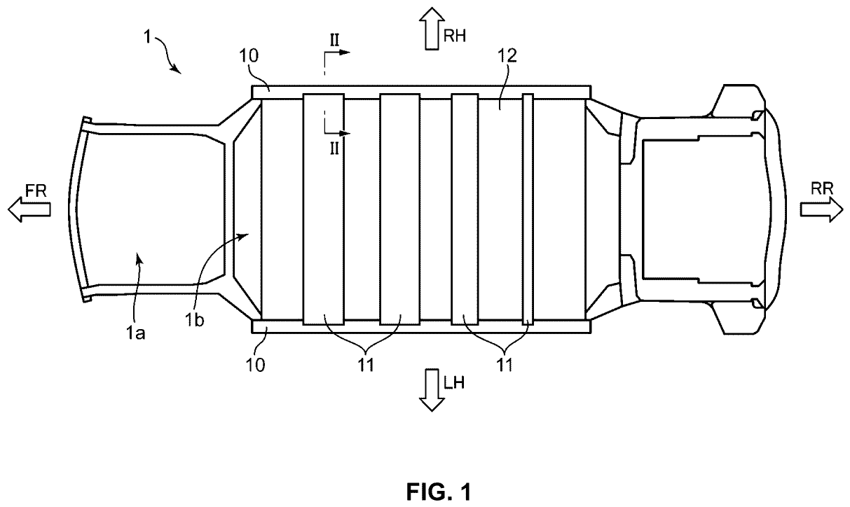

A structure of the vehicle 1 provided with a lower structure according to the present embodiment will be described referring to FIG. 1. FIG. 1 illustrates part of the vehicle 1 only, and illustrations of a powertrain and so on are omitted here.

As shown in FIG. 1, the vehicle 1 comprises a powertrain installment portion la where the powertrain is installed at its front portion and a floor portion 1b where a passenger stays, which is positioned on a rearward side of the powertrain installment portion la. A pair of side sills 10, plural cross members 11, and a battery 12 are arranged.

The pair of side sills 10 are arranged at both sides, in a vehicle width direction, of the floor portion 1b and extend in a longitudinal direction, respectively. The plural cross members 11 extend in the vehicle width direction, respectively, and fixed to the pair of side sills 10 at their both ends. The battery 12 supplies or receives the power (electric power) to or from the powertrain.

Herein, the battery 12 comprises battery cells which are constituted by lithium-ion battery, a nickel-metal hydride battery, or the like.

### 2. Fixation Structure of Side Sill 10, Cross Member 11, and Battery 12

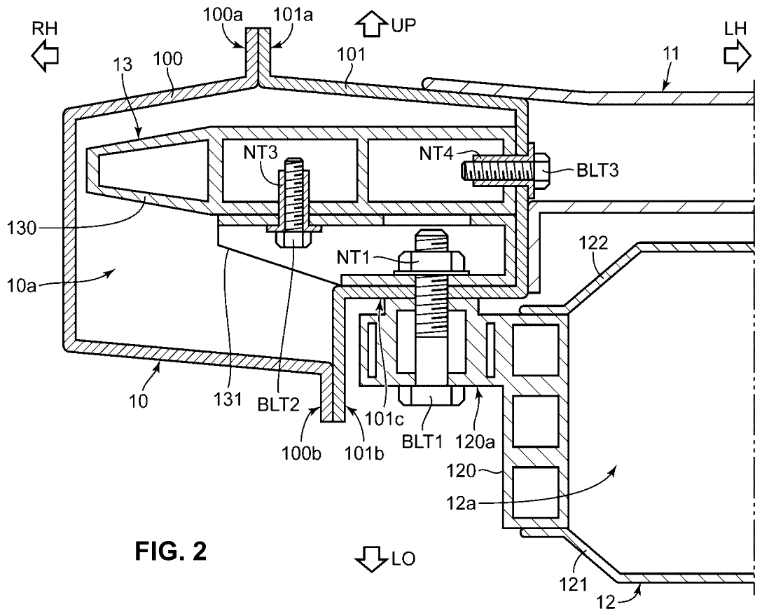

A fixation structure of the side sill 10, the cross member 11, and the battery 12 will be described referring to FIGS. 2 through 4. While FIG. 2 illustrates the right-side side sill 10 and its surrounding structure only, the left-side side sill 10 and its surrounding structure are substantially the same as those of the right-side side sill 10. These both are laterally symmetrical.

As shown in FIG. 2, the side sill 10 comprises a closed-cross section having a hollow portion 10a inside. Specifically, the side sill 10 is formed by fixing respective upper flange portions 100a, 101a and respective lower flange portions 100b, 101b of a side sill outer 100 and a side sill inner 101 which have a hat-shaped cross section, respectively.

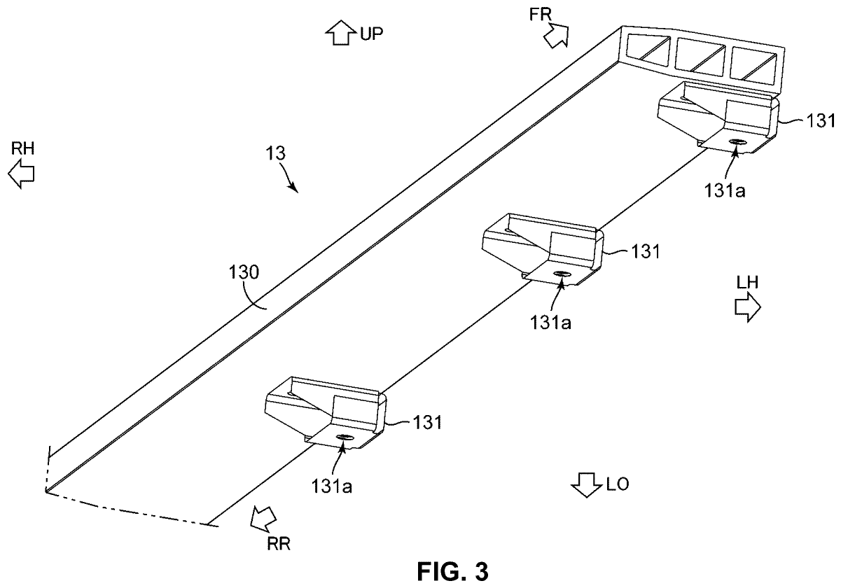

A reinforcing member 13 is stored in the hollow portion 10a. The reinforcing member 13 comprises a body portion 130 having a closed-cross section and brackets 131 arranged below the body portion 130. As shown in FIGS. 2 and 3, the body portion 130 of the reinforcing member 13 extends in the longitudinal direction along the side sill 10. Meanwhile, the plural brackets 131 are provided to be separated from each other in the longitudinal direction. The brackets 131 are fixed to an inward side, in the vehicle width direction, of a lower face of the body portion 130.

The body portion 130 and the bracket 131 are fixed together by a nut (blind nut) NT3 which is inserted into a penetration hole formed at the body portion 130 and a bolt BLT2 which is inserted into the nut NT3 from the side of the bracket 131 and screwed into the nut NT3. Herein, an outer diameter of the nut NT3 is enlarged inside the body portion 130 by screwing of the bolt BLT2 into the nut NT3, specific illustration of which is omitted here in FIG. 2, so that both the nut NT3 and the bolt BLT2 are prevented from being detached (dropped off) easily.

Herein, the fixation of the body portion 130 and the bracket 131 may be attained by providing a boss with a female screw at the body portion 130 and then screwing the bolt BLT2 into this female screw of the boss.

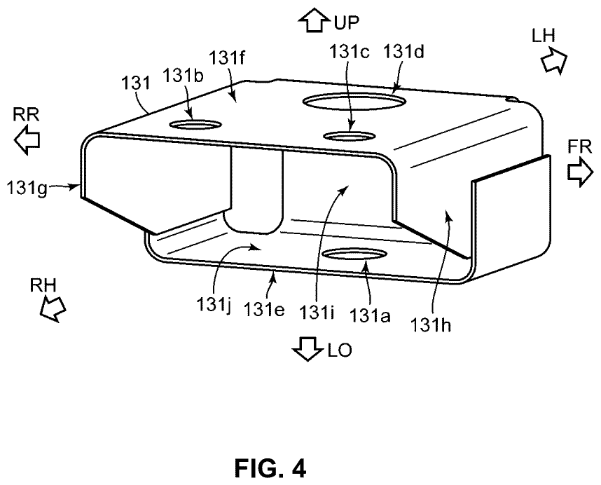

As shown in FIG. 4, each of the plural brackets 131 has an opening 131j at one side, in the vehicle width direction, thereof (the vehicle outward side in the present embodiment), and walls 131e-131i are formed at the other portion. The bracket 131 is configured such that the bottom wall 131e and the ceiling wall 131f face each other in the vertical direction and the side walls 131g, 131h face each other in the longitudinal direction. A penetration hole 131a is formed at the bottom wall 131e, and penetration holes 131b-131d are formed at the ceiling wall 131f. The penetration holes 131b, 131c are holes where the nut NT3 and the bolt BLT2 are inserted. The penetration hole 131a is a hole where a bolt BLT1 used for fixing the battery 12 is inserted, and the penetration hole 131d is a hole (service hole) which is used in the operation (work) of screwing the nut NT1 onto the bolt BLT1.

In the present embodiment, the body portion 130 of the reinforcing member 13 is fixed to the side sill inner 101. The fixation of the body portion 130 and the side sill inner 101 is attained by inserting a nut (blind nut) NT4 into penetration holes which are formed at the body portion 130 and the side sill inner 101 and screwing a bolt BLT3 which is inserted from the vehicle inward side of the side sill inner 101 into the nut NT4. Likewise, an outer diameter of the nut NT4 is enlarged inside the body portion 130 by screwing of the bolt BLT3 into the nut NT4, specific illustration of which is omitted here in FIG. 2, so that both the nut NT4 and the bolt BLT3 are prevented from being detached (dropped off) easily.

Herein, the fixation of the body portion 130 and the side sill inner 101 may be attained by providing a boss with a female screw at the body portion 130 and then screwing the bolt BLT3 into this female screw of the boss.

The cross member 11 extends in the vehicle width direction and is fixed to the side sills 10 at its both ends. A fixation manner of the cross member 111 to the side sill 10 can adopt various ways, such as bolt fastening or welding.

Herein, when the reinforcing member 13 and the cross member 11 are viewed from one side of the vehicle width direction, the reinforcing member 13 and the cross member 11 are arranged such that they overlap each other. Specifically, the body portion 130 of the reinforcing member 13 is located at a position which overlaps the cross member 11 in the side view.

The battery 12 comprises a structural body including a battery frame 120 which is configured to enclose the circumference of a direction crossing the vertical direction, a bottom wall 121 which is fixed to a lower portion of the battery frame 120, and a lid 122 which is fixed to an upper portion of the battery frame 120. Battery cells (not illustrated) are stored in a cell storage portion 12a which is enclosed by the battery frame 120, the bottom wall 121, and the lid 122.

As shown in FIG. 2, the battery frame 120 has a closed-cross section and an extension portion 120a extending to the outward side, in the vehicle with direction, of the vehicle body. The extension portion 120a has a penetration hole where the bolt BLT1 is inserted. The bolt BLT1 penetrates through a penetration hole (not illustrated) formed at a lower wall portion 101c of the side sill inner 101 and a penetration hole 131a (see FIGS. 3 and 4) of the bracket 131, and reaches inside the bracket 131 of the reinforcing member 13. The bolt BLT1 screws into the nut NT1 which is provided at its penetration position inside the bracket 131.

The bolt BLT1 of the present embodiment has a bar-shaped shaft portion and corresponds to the fixation member.

In the present embodiment, the lower wall portion 101c of the side sill inner 101 is fixed to the battery frame 120 by the bolt BLT1 screwing into the nut NT1 in a state where it is interposed between the bracket 131 of the reinforcing member 13 and the battery frame 120. In other words, the battery frame 120 is fixed to both the side sill 10 and the reinforcing member 13.

### 3. Move of Battery 12 When Side-Collion Load is Applied to Side Sill 10

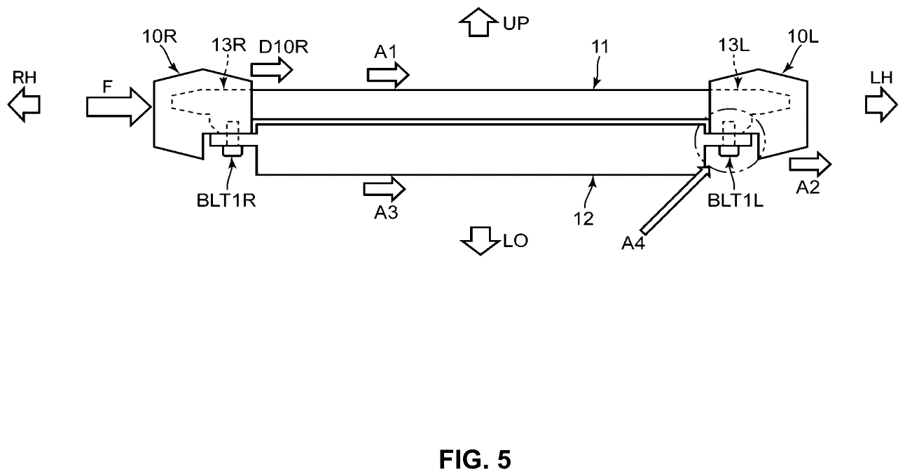

The move of the battery 12 when the side-collision load is applied to the side sill 10 will be described referring to FIG. 5. In the followings, a case where a side-collision load F is applied to a right-side side sill 10R from the vehicle outward side will be described. Even in a case where the side-collision load F is applied to a left-side side sill 10L from the vehicle outward, substantially the same move of the battery 12 happens.

As shown in FIG. 5, when the side-collision load F is applied to the right-side side sill 10R, the right-side side sill 10R moves to the left along with its deformation at an application point of the load F (an arrow D10R). A reinforcing member 13R stored the inside moves to the left as well according to the leftward move of the side sill 10R. Thereby, the cross member 11 which is arranged in the overlapping area moves to the left (an arrow A1).

As described above, since the battery 12 is fixed to the side sill 10R and a reinforcing member 12R by a bolt BLT1R, the battery 12 moves to the left according to the moves of the side sill 10R and the reinforcing member 13R (an arrow A3). Thus, in the vehicle 1 of the present embodiment, when the side-collision load F is applied to the side sill 10R, the battery 12 moves to the left together with the cross member 11 in a state where these two have a small relative move-difference. Accordingly, even if the left-side side sill 10L and the reinforcing member 13L have move/deformation as shown by an arrow A2 due to the pressing of the cross member 11, it is suppressed that a bolt BLT1L which fixes the battery 12 to the side sill 10L and the reinforcing member 13L gets broken (at a point shown by an arrow A4) and thereby the battery 12 gets detached from the side sill 10L.

### 4. Effects

In the vehicle 1 provided with the lower structure according to the present embodiment, the body potion 130 having the closed-cross section of the reinforcing member 13 is arranged in the overlapping area with the cross member 11 in the side view, the side-collision load F applied to the side sill 10 from the vehicle outward side is efficiently transmitted to the cross member 11. Further, even at the opposite side to the application side of the side-collision load F, since the reinforcing member 13 is arranged in the overlapping area with the cross member 11, the side-collision load F transmitted via the cross member 11 is efficiently transmitted to the side sill 10 (the opposite-side side sill 10 to the to the application side of the side-collision load F).

In the vehicle 1, the battery frame 120 is fixed not only to the side sill 10 but to the reinforcing member 13 by the bolt BLT1. Accordingly, even in a case where the side-collision load F is applied to the side sill 10 from the vehicle outward side, the battery frame 120 moves to the opposite side to the load-application side together with the cross member 11. Thereby, in the vehicle 1, even when the side-collision load F is applied to the one of the side sills 10 (the right-side side sill 10R in the example shown in FIG. 5), it can be suppressed that the fixation of the side sill 10 which is opposite to the application side of the side-collision load F (the left-side side sill 10L in the example shown in FIG. 5) and the battery 12 is released.

Herein, the battery 12 installed below the floor in the electric vehicle or the like has the large capacity and the large size and therefore it is heavy. Therefore, the battery frame 120 is configured to have the high rigidity. Thereby, the battery frame 120 where the load is transmitted via the bolt BLT1 may not be greatly deformed and broken compared to the cross member 11, so that when the side-collision load F is applied to the side sill 10, the relative move-difference between the cross member 11 and the battery frame 120 may not occur.

Further, in the vehicle 1 provided with the lower structure according to the present embodiment, the body portion 130 of the reinforcing member 13 has the closed-cross section and the bracket 131 of the reinforcing member 13 is fixed to the battery frame 120 by the bolt BLT1, the rigidity of the reinforcing member when the side-collision load F is applied to the side sill 10 is kept high, and also the fixation of the battery frame 120 and the reinforcing member 13 is made secure.

Further, in the vehicle 1 provided with the lower structure according to the present embodiment, the side sill 10, the reinforcing member 13, and the battery frame 120 are fixed together by the bolt BLT1 in the state where the lower wall portion 101c of the side sill 10 is interposed between the bracket 131 of the reinforcing member 13 and the battery frame 120. Accordingly, the battery frame 120 can be firmly fixed to the side sill 10 and the reinforcing member 13. That is, compared to a case where the lower wall portion 101c of the side sill 10 is fixed in a state where a gap is generated between the bracket 131 of the reinforcing member 13 or the battery frame 120, when the side-collision load F is applied to the side sill 10 from the vehicle outward side, the cross member 11 and the battery frame 120 do not have move difference easily due to resistance caused by a face contact of the both. Accordingly, even when the side-collision load F is applied to the one of the side sills 10 (the right-side side sill 10R of the example shown in FIG. 5), it can be further suppressed that the fixation of the other side sill 10 opposite to the load-application side (the left-side side sill 10L of the example in FIG. 5) and the battery 12 is released.

Also, in the vehicle 1 provided with the lower structure according to the present embodiment, since the body portion 130 including the part of the reinforcing member 13 having the closed-cross section is fixed to the side sill 10 by the bolt BLT3, the body portion 130 of the reinforcing member 13 moves toward the vehicle inward side together with the side sill 10 when the side-collision load F is applied to the side sill 10. Thereby, the load transmission to the cross member 11 is conducted by the body portion 130 of the reinforcing member 13 moving together with the side sill 10, and the load is properly transmitted to the battery frame 120 via the bolt BLT1.

Moreover, in the vehicle 1 provided with the lower structure according to the present embodiment, the bracket 131 is fixed to the body portion 130 of the reinforcing member 13 by the bolt BLT2, when the side-collision load F is applied to the side sill 10, the relative move-difference, vehicle width direction, between the body portion 130 and the bracket 131 does not occur easily. Thereby, even when the side-collision load F is applied to the one of the side sills 10 (the right-side side sill 10R of the example shown in FIG. 5), it can be further effectively suppressed that the fixation of the other side sill 10 opposite to the load-application side (the left-side side sill 10L of the example shown in FIG. 5) and the battery 12 is released.

Further, in the vehicle 1 provided with the lower structure according to the present embodiment, since the battery frame 120 have the closed-cross section as well, it is suppressed that the battery frame 120 is greatly deformed when the side-collision load F is applied to the side sill 10. Thereby, even when the side-collision load F is applied to the one of the side sills 10 (the right-side side sill 10R of the example shown in FIG. 5), it can be further effectively suppressed that the fixation of the other side sill 10 opposite to the load-application side (the left-side side sill 10L of the example shown in FIG. 5) and the battery 12 is released.

Also, in the vehicle 1 provided with the lower structure according to the present embodiment, since the bolt BLT1 is provided to extend in the vertical direction, the battery 12 is raised upward from a lower position and then the battery frame 120 can be fixed to the side sill 10 and the reinforcing member 13. That is, any troublesome operations for installing the battery 21 are unnecessary.

Moreover, when the side-collision load F is applied to the side sill 10, the load can be transmitted to the battery frame 120 via the bolt BML1 extending in the vertical direction.

Further, in the vehicle 1 provided with the lower structure according to the present embodiment, since the battery frame 120 and the reinforcing member 13 are fixed to the side sill inner 101, even when the side-collision load F is applied to the part, in the longitudinal direction, of the side sill 10, it can be suppressed that a joint point (by welding or the like) of the side sill inner 101 and the vehicle body, such as a floor panel, is released. That is, the side sill 10 tends to be deformed in a bent shape in the plan view when the side-collision load F is applied to the side sill 10. However, since the side sill 10 and the reinforcing member 13 are fixed to the battery frame 120 having the high rigidity, it can be suppressed that the side sill 10 is deformed in the bent shape by a reaction force from the battery frame 120. Accordingly, releasing of the joint point of the side sill 10 and the vehicle body due to the application of the side-collision load F to the part of the side sill 10 can be suppressed properly.

As described above, in the vehicle 1 provided with the lower structure according to the present embodiment, even when the side-collision load is applied to the side sill from the vehicle outward side, it can be properly suppressed that the fixation of the side sill and the battery is released.

### Modification 1

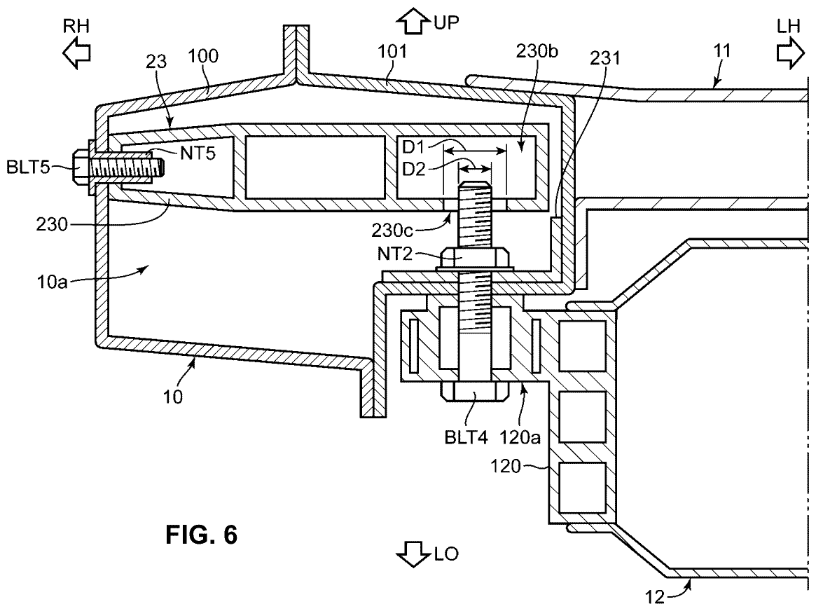

A lower structure according to a first modification will be described referring to FIG. 6. In the present modification, a structure of a reinforcing member 23 is different from the above-described embodiment, and the other structure is the same as the above-described embodiment. Hereafter, the structure of the reinforcing member 23 will be described.

As shown in FIG. 6, the reinforcing member 23 comprises a body portion 230 which includes part thereof having the closed-cross section and a bracket 231 which is fixed to the battery frame 120. In the reinforcing member 23 of the present modification, the body portion 230 and the bracket 231 are separated from each other, not being fixed together.

The body portion 230 of the reinforcing member 23 is, similarly to the above-described embodiment, arranged inside the hollow portion 10a of the side sill 10 in an overlapping area, in the side view, with the cross member 11. The body portion 230 is fixed to the side sill outer 100. The fixation of the body portion 230 and the side sill outer 100 is attained by a structure in which a nut (blind nut) NT5 is inserted into penetration holes formed at the body portion 230 and the side sill outer 100 and a bolt BLT5 inserted from the vehicle outward side of the side sill outer 100 screws into the nut NT5. Likewise, the outer diameter of the nut NT5 is enlarged inside the body portion 130 by the bolt BLT5 screwing into a female screw of the nut NT5, so that the nut NT5 and the bolt BLT5 are prevented from being detached.

Herein, the fixation of the body portion 130 and the side sill outer 100 may be conducted by a structure in which a boss with female screw is provided at the body portion 130 and the bolt BLT5 screws into the female screw of the boss.

The battery frame 120 of the present modification has the closed-cross section and an extension portion 120a extending in the vehicle-outward direction as well. The extension portion 120a has a penetration hole where a bolt BLT4 is inserted, and the bolt BLT4 passes through a penetration hole formed at the lower wall portion of the side sill inner 101 and a penetration hole of the bracket 231 and partially reaches an inside of a hollow portion 230b of the body portion 230. The nut NT1 screws onto the bolt BLT4 on the bracket 231, whereby the battery frame 120, the side sill 10, and the bracket 231 are fixed together.

The body portion 230 of the reinforcing member 23 has an opening 230c where a tip of the bolt BLT4 penetrates. An opening diameter (opening size) D1 of the opening 230c is set to be larger than a diameter (section size) D2 of a shaft portion (penetrating part) of the bolt BLT4. Herein, when the side-collision load is not applied to the side sill 10, there exists a gap between an outer peripheral face of a shaft portion of the bolt BLT4 and an inner peripheral face of the opening 230c.

In the present modification, the body portion 230 of the reinforcing member 23 is not fixed to the battery frame 120.

Herein, the bracket 231 is not indispensable for the reinforcing member 23. That is, that is unnecessary as long as part of the bolt BLT4 which is fixed to the side sill inner 101 by screwing into the nut NT2 passes through the opening 230c and reaches the inside of the body portion 230.

The vehicle provided with the lower structure according to the present modification can perform the same effects as the above-described embodiment. Further, in the present modification, the opening 230c with a opening diameter D1 is formed at the body portion 230 of the reinforcing member 23, and the shaft portion of the bolt BLT4 passes through the opening 230c and reaches the inside thereof. That is, in a case where the side-collision load is applied to the side sill 10, the shaft portion of the bolt BLT4 and the inner peripheral face of the opening 230c of the body portion 230 do not contact each other, so that any noises caused by the contacting can be suppressed. Meanwhile, in a case where the side-collision load is applied to the side sill 10 and the reinforcing member 23 moves to the vehicle inward side according to the deformation or move of the side sill 10, the shaft portion of the bolt BLT4 and the inner peripheral face of the opening 230c contact each other. Thereby, part of the side-collision load applied to the side sill 10 is transmitted to the battery frame 120 via the bolt BLT4 as well, so that the battery frame 120 can be made to move together with the cross member 11 in the vehicle side collision.

### Modification 2

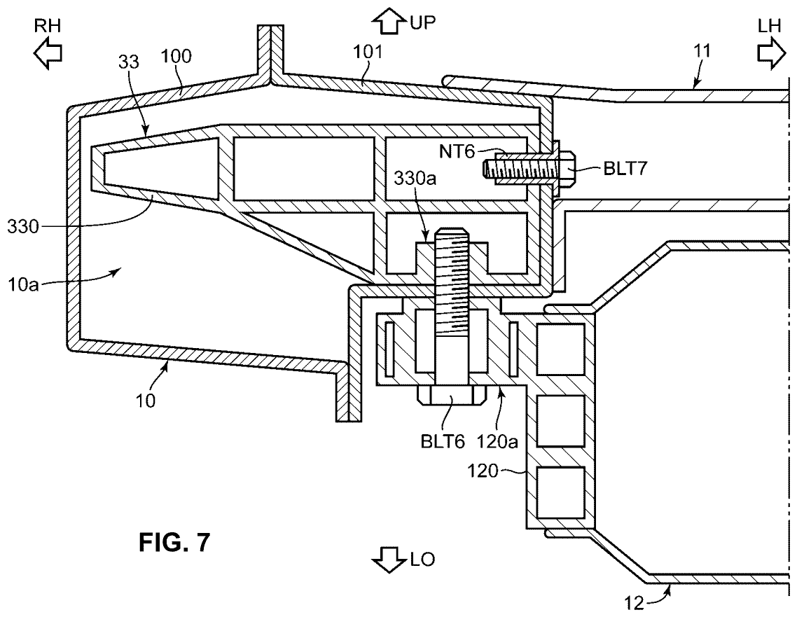

A lower structure according to a second modification will be described referring to FIG. 7. In the present modification, a structure of a reinforcing member 33 is different from the above-described embodiment, and the other structure is the same as the above-described embodiment. Hereafter, the structure of the reinforcing member 33 will be described.

As shown in FIG. 7, the reinforcing member 33 is constituted by a body portion 330 which including part thereof having the closed-cross section. That is, the reinforcing member 33 of this modification does not comprise any bracket like the brackets 131, 231 of the above-described embodiments and the first modification, and the battery frame 120 is fixed to the body portion 330 directly in the second modification.

A bolt BLT6 which penetrates the extension portion 120a of the battery frame 120 is configured such that its shaft portion penetrates the body portion 330 of the reinforcing member 33. A boss 330a with a female screw is formed at a penetration portion of the bolt BLT6 at the body portion 330. The bolt BLT6 screws into the female screw formed at the boss 330a, whereby the battery frame 120 is fixed to the side sill 10 and the reinforcing member 33.

Herein, in the fixation of the battery frame 120 and the body portion 330 of the reinforcing member 33, it is not indispensable that the bolt BLT6 screws into the female screw formed at the boss 330a. For example, a nut may be arranged inside the body portion 330, and the battery frame 120 and the reinforcing member 33 may be fixed by making the bolt BLT6 into this nut.

In this modification, the reinforcing member 33 is fixed to the side sill inner 101. The fixation of the reinforcing member 33 and the side sill inner 101 is attained by a structure in which a nut (blind nut) NT6 is inserted into penetration holes formed at the body portion 330 and the side sill inner 101 and a bolt BLT7 inserted from the vehicle inward side of the side sill inner 101 screws into the nut NT6. The outer diameter of the nut NT6 is enlarged inside the body portion 130 by the bolt BLT6 screwing into a female screw of the nut NT6, so that the nut NT6 and the bolt BLT7 are prevented from being detached.

Herein, the fixation of the body portion 130 and the side sill inner 101 may be conducted by a structure in which a boss with female screw is provided at the body portion 130 and the bolt BLT7 screws into the female screw of the boss.

While the lower structure according to this modification is different from the above-described embodiments because no bracket is provided at the reinforcing member 33, the other structure is the same and the same effects are performed by this modification.

### Other Modifications

While the bolts BLT1, BLT4, BLT6 are used as the fixing member in the above-described embodiment and the first and second modifications, any fixing member, such as a rivet, is applicable in the present invention.

Further, while the body portions 130, 330 of the reinforcing members 13, 33 are fixed to the side sill inner 101 in the above-described embodiment and second modification and the body portion 230 of the reinforcing member 23 is fixed to the side sill outer 10 in the above-described first modification, any fixation is applicable in the present invention as long as the body portion of the reinforcing member is fixed to at least one of the side sill outer and the side sill inner.

What is claimed is:

1. A lower structure of a vehicle, comprising:
a pair of side sills arranged at both outward sides, in a vehicle width direction, of a floor of the vehicle, extending in a longitudinal direction of the vehicle, and having a closed-cross section with a hollow portion inside, respectively;
a cross member extending in the vehicle width direction and fixed to the pair of side sills at both ends thereof;
a battery arranged below the cross member under the floor of the vehicle and having a battery frame extending in the longitudinal direction of the vehicle on an inward side, in the vehicle width direction, of each of the pair of side sills;
a reinforcing member stored in the hollow portion of each of the pair of side sills, the reinforcing member being configured such that at least part thereof has a closed-cross section and the part thereof having the closed-cross section is arranged in an area which overlaps the cross member in a side view of the vehicle, when viewed from one side of the vehicle width direction; and
a fixing member to fix the battery frame of the battery to each of the pair of side sills,
wherein said fixing member is configured such that part thereof penetrates said reinforcing member and the fixing member fixes said battery frame to said side sill together with the reinforcing member.

2. The lower structure of the vehicle of claim 1, wherein said reinforcing member comprises a body portion including said part of the reinforcing member having the closed-cross section and a bracket arranged below said body portion, and said fixing member is configured such that part thereof penetrates said bracket and the fixing member fixes the bracket to said battery frame.

3. The lower structure of the vehicle of claim 2, wherein said fixing member is configured such that part thereof penetrates said body portion.

4. The lower structure of the vehicle of claim 3, wherein a portion of said fixing member which penetrates said body portion has a bar shape, and a portion of said body portion of the reinforcing member where said part of the fixing member penetrates has an opening with a size which is larger than a sectional size of said bar-shaped portion of the fixing member.

5. The lower structure of the vehicle of claim 2, wherein said side sill is fixed to said battery frame in a state where part of an outer wall of the side sill is interposed between said bracket and said battery frame.

6. The lower structure of the vehicle of claim 2, wherein said body portion of the reinforcing member is fixed to said side sill at least one of an inward side and an outward side, in the vehicle width direction, thereof.

7. The lower structure of the vehicle of claim 2, wherein said bracket is fixed to said body portion of the reinforcing member.

8. The lower structure of the vehicle of claim 1, wherein at least part of said battery frame has a closed-cross section, and said fixing member fixes said part of the battery frame having the closed-cross section to said side sill and said reinforcing member.

9. The lower structure of the vehicle of claim 8, wherein said fixing member is provided to extend upward, in a vertical direction, of the vehicle toward said reinforcing member from said part of the battery frame having the closed-cross section.

10. The lower structure of the vehicle of claim 1, wherein each of said pair of side sills comprises a side sill outer provided on the outward side, in the vehicle width direction, thereof and a side sill inner provided on the inward side, in the vehicle width direction, thereof and fixed to said side sill outer, and said battery frame and said reinforcing member are fixed to said side sill inner by said fixing member.

11. The lower structure of the vehicle of claim 3, wherein each of said pair of side sills comprises a side sill outer provided on the outward side, in the vehicle width direction, thereof and a side sill inner provided on the inward side, in the vehicle width direction, thereof and fixed to said side sill outer, and said battery frame and said reinforcing member are fixed to said side sill inner by said fixing member.

12. The lower structure of the vehicle of claim 5, wherein each of said pair of side sills comprises a side sill outer provided on the outward side, in the vehicle width direction, thereof and a side sill inner provided on the inward side, in the vehicle width direction, thereof and fixed to said side sill outer, and said battery frame and said reinforcing member are fixed to said side sill inner by said fixing member.

13. The lower structure of the vehicle of claim 6, wherein each of said pair of side sills comprises a side sill outer provided on the outward side, in the vehicle width direction, thereof and a side sill inner provided on the inward side, in the vehicle width direction, thereof and fixed to said side sill outer, and said battery frame and said reinforcing member are fixed to said side sill inner by said fixing member.

14. The lower structure of the vehicle of claim 7, wherein each of said pair of side sills comprises a side sill outer provided on the outward side, in the vehicle width direction, thereof and a side sill inner provided on the inward side, in the vehicle width direction, thereof and fixed to said side sill outer, and said battery frame and said reinforcing member are fixed to said side sill inner by said fixing member.

15. A. The lower structure of the vehicle of claim 1, wherein said reinforcing member is fastened to said side sill in the vehicle width direction.

16. A. The lower structure of the vehicle of claim 3, wherein said reinforcing member is fastened to said side sill in the vehicle width direction.

17. A. The lower structure of the vehicle of claim 5, wherein said reinforcing member is fastened to said side sill in the vehicle width direction.

18. A. The lower structure of the vehicle of claim 6, wherein said reinforcing member is fastened to said side sill in the vehicle width direction.

19. A. The lower structure of the vehicle of claim 7, wherein said reinforcing member is fastened to said side sill in the vehicle width direction.

20. A. The lower structure of the vehicle of claim 9, wherein said reinforcing member is fastened to said side sill in the vehicle width direction.
